(19) United States
(12) Patent Application Publication
(10) Pub. No.: US 2012/0234978 A1
(43) Pub. Date: Sep. 20, 2012

(54) LOAD TRANSFER DEVICES AT A STRINGER RUN-OUT

(75) Inventors: Sofia Hernando Navas, Madrid (ES); Santiago Cervigón Huete, Madrid (ES); José Gregorio Iniesta Menéndez, Madrid (ES); Alberto Arana Hidalgo, Madrid (ES)

(73) Assignee: AIRBUS OPERATIONS S.L., Madrid (ES)

(21) Appl. No.: 13/112,269

(22) Filed: May 20, 2011

(30) Foreign Application Priority Data
Mar. 14, 2011 (ES) 201130344

(51) Int. Cl. B64C 1/12; B64C 3/18; B64C 1/06

(52) U.S. Cl. 244/132

(57) ABSTRACT

Device for transferring in an stiffened skin of an aircraft component made of a composite material the load of an stringer (16) to the skin (11) in a stringer run-out zone, the stringer (16) being configured by a web (31) and a foot (33), comprising two brackets (40, 40′) configured as unitary parts by webs (41, 41′) to be joined to each side of the stringer web (31) in said run-out zone and feet (43, 43′) having a first section (45, 45′) to be joined to each side of the stringer foot (33) in said run-out zone and a second section (47, 47′) to be joined to the skin (11). An aircraft component made of a composite material using said device in the stringer run-outs

### FIELD OF THE INVENTION

The present invention refers to load transfer devices at a stringer run-out in composite parts stiffened with stringers and more in particular in composite parts belonging to aircraft lifting surfaces.

### BACKGROUND OF THE INVENTION

The main structure for aircraft lifting surfaces consists of a leading edge, a torsion box, a trailing edge, a root joint and a tip. The torsion box consists of several structural elements: upper and lower skins stiffened by stringers on one side and spars and ribs on the other side. Typically, the structural elements forming the torsion box are manufactured separately and are joined with the aid of complicated tooling to achieve the necessary tolerances, which are given by the aerodynamic, assembly and structural requirements.

Nowadays, and particularly in the aeronautical industry, composite materials with an organic matrix and continuous fibres, especially CFRP (Carbon Fibre Reinforced Plastic) are widely used in a great variety of structural elements. For example, all the elements which make up a torsion box enumerated beforehand (ribs, stringers, spars and skins) can be manufactured using CFRP.

The skins which make up the torsion boxes are stiffened with span wise longitudinal stringers that improve both the strength and the buckling behaviour of the skins having different cross sections such as “T”, “I” or “J” shaped cross sections. Full height of stringer benefits the stability of the panel by means of a bigger inertia in the stiffening element.

Typically the stringers are placed parallel between themselves forming a certain angle with both front and rear spars. This configuration permits the orientation of the stringers along the maximum load direction, as well as an increase in their number in the region with the greatest structural responsibility.

This configuration with parallel stringers, together with the fact that both spars are not parallel to each other, means that while the stringers get closer to the spar they are interrupted by the presence of said spar.

The end of a stringer, both due to the intersection with the front spar or due to any other reasons, causes a redistribution of the loads carried by the stringer and the skin before the termination onto just the skin panel (unstiffened) after the termination. This causes two main effects:
While the upbending or downbending of the stiffened skin causes tension and compression cases, this discrete change in the structural arrangement of the skin at the stringer termination (stringer run-out) causes a moment at the stringer run-out that tends to peel the bonding line between the stringer and the skin.
At the same time, the load redistribution has to take place through a bonding line to pass the load carried by the stringer to the skin after the stringer run-out. In case of high load levels (as those experienced in a wing) causes that the bonding strength is compromised at such high loads.

A known approach to reduce the load re-distribution at the stringer run-out, disclosed for instance in U.S. Pat. Nos. 4,606,961 and 7,682,787, is to progressively reduce the load carried by the stringer before the stringer termination by means of reducing the cross section (reducing height and/or thickness) and then compromising the buckling stability of the skin panel before the stringer termination that can only be counterbalanced by an increase of thickness of this previous panel. This weight increase is a drawback of this approach.

WO 2008/132498 discloses a proposal that, apart from a using a stringer with a tapered web at the run-out, includes a pad embedded in a recess in the panel that protrudes downwardly from the base of the stringer and extends beyond the ends of the stringer web and flanges. The main drawback of this proposal is that involves serious manufacturing problems.

This invention is focused on the solution of said drawbacks.

### SUMMARY OF THE INVENTION

It is an object of the present invention to provide a stringer run-out assembly in a stiffened skin of the torsion box of an aircraft lifting surface, particularly a wing, made of a composite material, particularly CFRP, able to transfer the loads to the skin avoiding peeling and debonding risks.

It is another object of the present invention to provide a stringer run-out assembly in a stiffened skin of the torsion box of an aircraft lifting surface, particularly a wing, made of a composite material, particularly CFRP, able to transfer the loads to the skin avoiding the loss of bucking stability in the surrounding panels.

In one aspect, these and another objects are met by a device for transferring the load of an stringer to the skin in a stringer run-out zone, the stringer being configured by a web and a foot, that comprises two brackets configured as unitary parts by webs to be joined to each side of the stringer web in said run-out zone and feet having a first section to be joined to each side of the stringer foot in said run-out zone and a second section to be joined to the skin.

In embodiments of the present invention, in the final section of said run-out zone the stringer includes a tapered web and a wider foot and the brackets also include tapered webs and wider feet. It is important to note that, due to the role of the brackets as load transfer devices, said final section can be shorter than in the prior art, attending more to design requirements, such those to be taken into account in an intersection with a rib, than to load transfer requirements.

In embodiments of the present invention said brackets are made with a metallic material, particularly aluminum.

In another aspect, the above-mentioned objects are met by an aircraft component made of a composite material comprising a skin stiffened by a plurality of stringers configured by a web and a foot, the component having at least one stringer terminating at the proximity of another structural element in a run-out zone, that also comprise two brackets for transferring the stringer load in said run-out zone to the skin, each bracket being configured as an unitary part by a web joined to each side of the stringer web in said run-out zone and by a foot having a first section joined to each side of the stringer foot in said run-out zone and a second section joined to the skin.

In embodiments of the invention, in the final section of said run-out zone of said component the stringer includes a tapered web and a wider foot, and the brackets also include tapered webs and wider feet. As it can be easily understood, the configuration of the brackets of the invention is dependant of the configuration of the stringer run-out so that the invention is applicable to any stringer run-out configuration.

Although the invention is applicable to any aircraft lifting surface, it is considered that aircraft wings are the preferred field of application due to the amount of the loads to be transferred in the stringer run-outs.

### BRIEF DESCRIPTION OF THE FIGURES

Other characteristics and advantages of the present invention will be clear from the following detailed description of embodiments illustrative of its object in relation to the attached figures.

FIG. 1 shows the typical structural configuration of a torsion box, except for the upper skin, which has been removed to improve the visibility of the interior.

FIG. 2 shows a portion of a skin of a typical torsion box where several stringers end close to the front spar.

FIGS. 3a and 3b are schematic plan and cross sectional views of a first stringer run-out configuration with and without the brackets according to this invention.

FIGS. 4a and 4b are schematic plan and cross sectional views of a second stringer run-out configuration with and without the brackets according to this invention.

FIG. 5 shows perspective views of said second stringer run-out configuration with and without the brackets according to this invention.

FIG. 6 is a schematic plan view of a stringer run-out with the brackets according to this invention in an intersection with a rib.

### DETAILED DESCRIPTION OF THE INVENTION

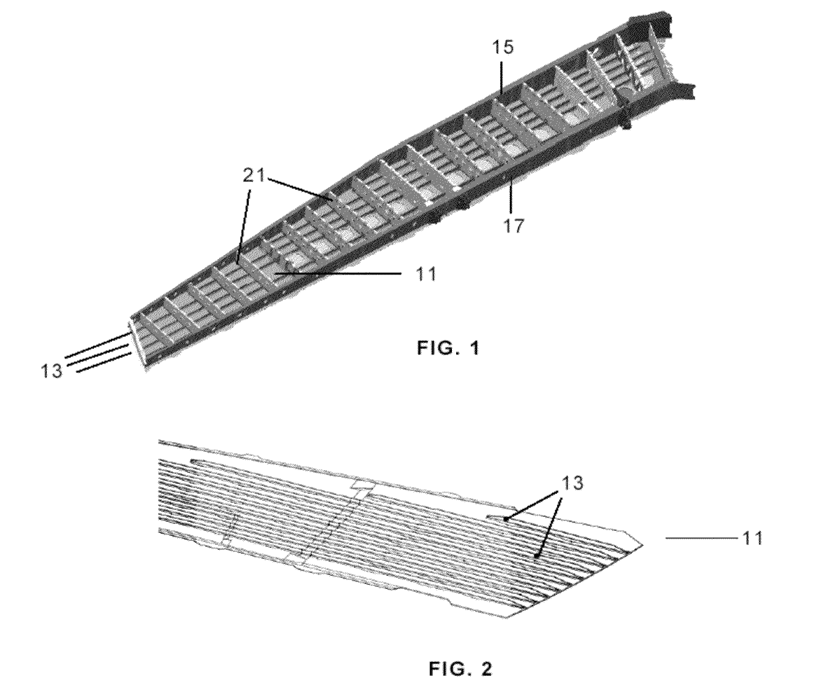

FIG. 1 shows a typical torsion box of an aircraft lifting surface made up by an upper skin (not shown to facilitate the identification of the different parts), a lower skin 11 reinforced with longitudinal stringers 13 (attached to the skin by, usually, bonding means), a front spar 15, a rear spar 17 and ribs 21.

FIG. 2 shows a portion of a skin 11 stiffened with T-shaped stringers 13 having some of them terminating close to the front spar.

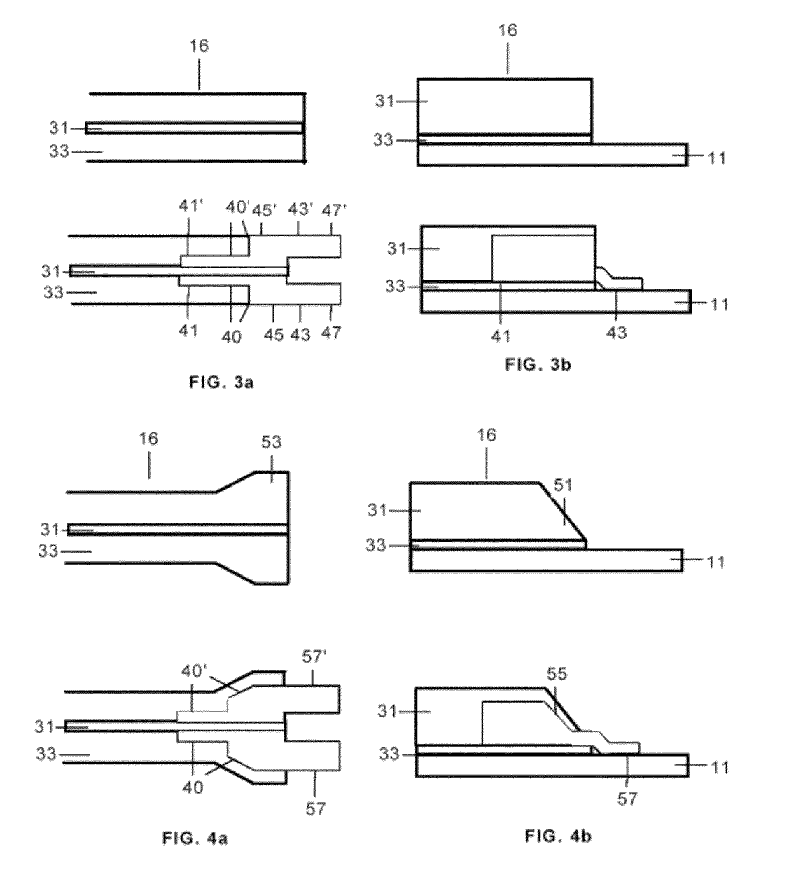

FIGS. 3a and 3b show a stringer run-out with and without the device for transferring the load of the stringer 16 to the skin 11 according to the invention. The stringer is a T-shaped stringer with a web 31 and a foot 33 extending at both sides of the web 31. The invention is also applicable to any other stringer whose configuration includes a web and a foot.

The device comprise two brackets 40, 40′ at each side of the stringer web 31 formed by webs 41, 41′ and feet 43, 43′ integrated as unitary parts. The bracket webs 41, 41′ are joined to the stringer web 31 and the bracket feet 43, 43′ are joined to the stringer feet 33 in a first section 45, 45′ and to the skin 11 in a second section 47, 47′. Bolts are suitable means for carrying out said joints.

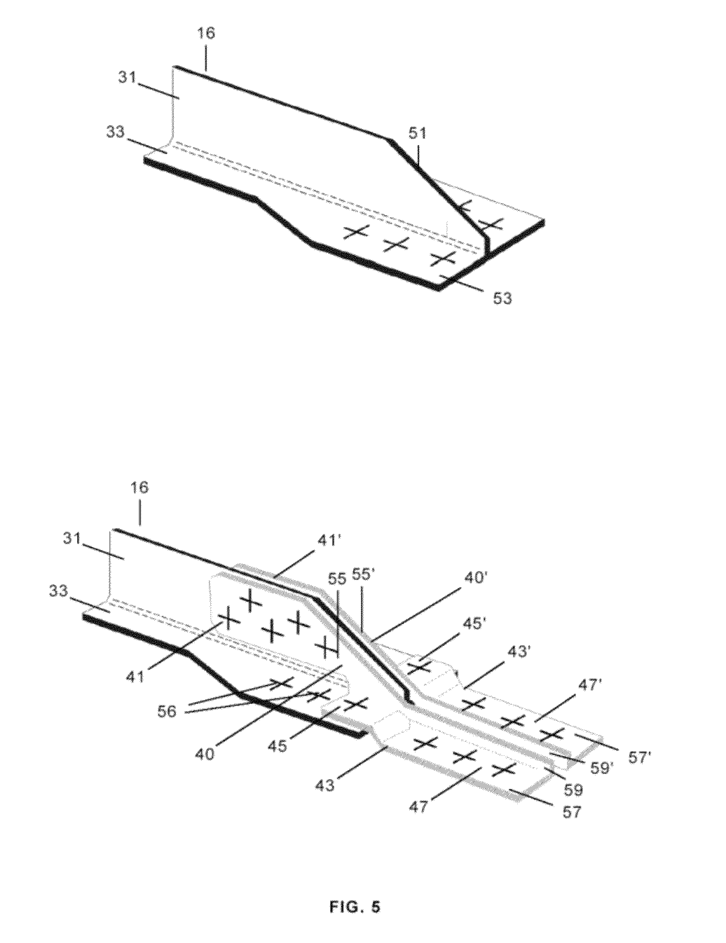

FIGS. 4a, 4b and 5 show preferred embodiments for an stringer run-out with a tapered web 51 and a wider foot 53 in its final zone and bracket webs 41, 41′ and bracket feet 43, 43′ having a configuration adapted to the stringer run-out configuration with final zones 55, 55′ and 57, 57′.

The main difference between these embodiments is that in the case of FIG. 5 the first sections 45, 45′ of bracket feet 43, 43′ are shorter than in FIGS. 4a, 4b so that they not interfere with rib-stringer join bolts 56. Having this design the brackets 40, 40′ can be mounted in a later stage of the manufacturing process because they do not interfere with the ribs.

FIG. 5 also show brackets 40, 40′ with a design in the transitional area between bracket webs 41, 41′ and bracket feet 43, 43′ incorporating vertical nerves 59, 59′ to the bracket feet 43, 43′ for improving the load transfer.

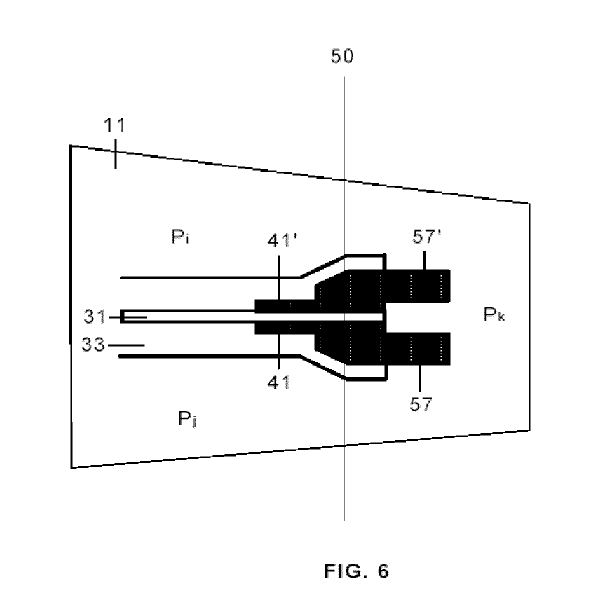

FIG. 6 shows an stringer run-out in the intersection with a rib following the line 50, which is a typical stringer termination in aircraft wings, delimiting three panels Pᵢ, Pⱼ, Pₖ that helps to understand the main effects of the device according to this invention:
Minimize the peeling effect at the stringer end by means, mainly, of the bracket feet 43, 43′ bolted to the stringer foot 33.
Minimize the bonding line load transfer by means of transferring the part of the load in the stringer web 31 by means of both the brackets webs 41, 41′ and the brackets feet 43, 43′ that transfer the load to the panel Pₖ beyond the stringer termination.
Minimize the loss of buckling stability in the previous skin panels Pᵢ, Pⱼ once the stringer does not require a height reduction before the stringer termination.

An important advantage of the present invention is that said brackets 40, 40′ can be used both in the design/manufacturing stage of the aircraft component as in a reparation stage.

Another important advantage of the present invention is that the configuration of said brackets 40, 40′ can be adapted to particular needs such as avoiding interferences with rib joints or complying with specific load transfer requirements such as those mentioned above.

Although the present invention has been fully described in connection with preferred embodiments, it is evident that modifications may be introduced within the scope thereof, not considering this as limited by these embodiments, but by the contents of the following claims.

1. A device for transferring in an stiffened skin of an aircraft component made of a composite material the load of an stringer (16) to the skin (11) in a stringer run-out zone, the stringer (16) being configured by a web (31) and a foot (33), characterized by comprising two brackets (40, 40′) configured as unitary parts by webs (41, 41′) to be joined to each side of the stringer web (31) in said run-out zone and feet (43, 43′) having a first section (45, 45′) to be joined to each side of the stringer foot (33) in said run-out zone and a second section (47, 47′) to be joined to the skin (11).

2. A device according to claim 1, wherein the final section of said run-out zone the stringer (16) includes a tapered web (51) and a wider foot (53), and the brackets (40, 40′) also include tapered webs (55, 55′) and wider feet (57, 57′).

3. A device according to claim 1, wherein said brackets (40, 40′) are made with a metallic material.

4. An aircraft component made of a composite material comprising a skin (11) stiffened by a plurality of stringers configured by a web (31) and a foot (33), the component having at least one stringer (16) terminating at the proximity of another structural element in a run-out zone, characterized in that also comprise two brackets (40, 40′) for transferring the stringer load in said run-out zone to the skin (11), each bracket (40, 40′) being configured as an unitary part by a web (41, 41′) joined to each side of the stringer web (31) in said run-out zone and by a foot (43, 43′) having a first section (45, 45′) joined to each side of the stringer foot (33) in said run-out zone and a second section (47, 47′) joined to the skin (11).

5. An aircraft component according to claim 4, wherein the final section of said run-out zone the stringer (16) includes a tapered web (51) and a wider foot (53), and the brackets (40, 40′) also include tapered webs (55, 55′) and wider feet (57, 57′).

6. An aircraft component according to claim 4, wherein said joints are carried out with bolts.

7. An aircraft component according to claim 4, wherein said brackets (40, 40′) are made with a metallic material.

8. An aircraft component according to claim 4, wherein the component belongs to the torsion box of an aircraft wing.
